(19) United States
(12) Patent Application Publication
(10) Pub. No.: US 2016/0210639 A1
(43) Pub. Date: Jul. 21, 2016

(54) Lead Generation Using Trait-Based Matching of Consumer to Service Providers

(71) Applicant: Insurance Portal Services, LLC, Virginia Beach, VA (US)

(72) Inventors: Joseph P.G. Kindley, Virginia Beach, VA (US); Berkley D. Jolly, Virginia Beach, VA (US); James C. Petersen, III, Richmond, VA (US)

(21) Appl. No.: 14/990,003

(22) Filed: Jan. 7, 2016

Related U.S. Application Data
(60) Provisional application No. 62/125,391, filed on Jan. 19, 2015.

(51) Int. Cl. G06Q 30/02; G06F 17/30

(52) U.S. Cl. CPC G06Q 30/0201; G06F 17/3053

(57) ABSTRACT

A method, system, and computer-readable storage device are provided for the generation of sales leads for a service provider. Traits valued by service providers operating in an identical competitive industry are stored. For each service provider, each of their traits identifies one of preferred consumer demographics and preferred business demographics. Data collected from a consumer includes the consumer's personal information and information associated with a service provided by the service providers. The consumer's data is compared with the traits of the service providers to identify at least one of the service providers whose traits correlate to the data associated with the consumer. The consumer is then identified to the one or more service providers whose traits correlate to the data associated with the consumer.

Pursuant to 35 U.S.C. §119, the benefit of priority from provisional application 62/125,391, with a filing date of Jan. 19, 2015, is claimed for this non-provisional application.

### FIELD OF THE INVENTION

The invention relates generally to customer lead generation, and more particularly to method of matching a consumer to one or more service providers (e.g., auto insurance providers) where matching is based on correlating a number of the consumer's traits with service providers who value the consumer's traits.

### BACKGROUND OF THE INVENTION

Consumers are purchasing more and more products online. In general, a consumer either visits a particular seller's website to search for a product that the seller is known to sell, or uses a search engine to search for the generic product and then selects a seller based on the return “hits” from the search engine. In both cases, the consumer selects a seller without knowing if that seller is a good match for the consumer's needs.

The above-described searching and purchasing process has many disadvantages when the product is a service whose cost and value can vary widely based on a consumer's particular situation and needs. For example, when the product is auto insurance, the above-described online searching and purchasing model has disadvantages for both the consumer and seller (insurance provider). The consumer must select one or more insurance providers and then provide a fairly extensive amount of personal and historical information at each selected provider's website. Each insurance provider then provides that consumer with an insurance quote that is based on some type of quoting algorithm that, in general, produces a quote based on an insurance producer's desired demographic where a higher quote is returned for those consumers that do not match the demographic criteria. Since the consumer has no knowledge of what an insurance provider considers desirable, the consumer can often receive multiple high quotes thereby only leaving them with only high-cost alternatives. From the insurance company's perspective, their quoting efforts can be wasted by providing high quotes for a consumer that will ultimately not purchase their product due to cost.

More recently, some comparative insurance quote services collect very basic personal information from a consumer to generate multiple insurance product estimates from multiple insurance companies. However, these estimates are not generated using each insurance provider's quoting algorithm. As a result, the consumer must still visit each provider's website and supply his personal information at each provider website to get a true product quote.

### SUMMARY OF THE INVENTION

Accordingly, it is an object of the present invention to provide a method of generating leads for sellers by matching a consumer to one or more sellers who value that consumer.

Another object of the present invention is to provide a method of matching an auto insurance consumer to one or more auto insurance providers based on a consumer's traits and a provider's desired demographics.

Other objects and advantages of the present invention will become more obvious hereinafter in the specification and drawings.

In accordance with the present invention, a method, system and computer-readable storage device are provided for the generation of sales leads for a service provider. Traits valued by each of a plurality of service providers operating in an identical competitive industry are stored. For each service provider, each of their traits identifies one of preferred consumer demographics and preferred business demographics. Data collected from a consumer includes the consumer's personal information and information associated with a service provided by the service providers. The consumer's data is compared with the traits of the service providers to identify at least one of the service providers whose traits correlate to the data associated with the consumer. The consumer is then identified to the one or more service providers whose traits correlate to the data associated with the consumer.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a top-level schematic view of a system for carrying out the method of lead generation using trait-based matching of a consumer to one or more auto insurance providers in accordance with an embodiment of the present invention;

FIG. 2 is a table of provider traits with valuations used in trait tag matching in accordance with an embodiment of the present invention;

FIG. 3 is a flow diagram of the method of lead generation using trait-based matching in accordance with an embodiment of the present invention;

FIG. 4 is a table of consumer trait tags used in trait tag matching in accordance with an embodiment of the present invention;

FIG. 5 is a flow diagram of a post lead generation process in accordance with an embodiment of the present invention;

FIG. 6 is a table of provider traits with valuations used in trait tag matching in accordance with another embodiment of the present invention; and

FIG. 7 is a table of provider traits with valuations used in trait tag matching in accordance with still another embodiment of the present invention.

### DETAILED DESCRIPTION OF THE INVENTION

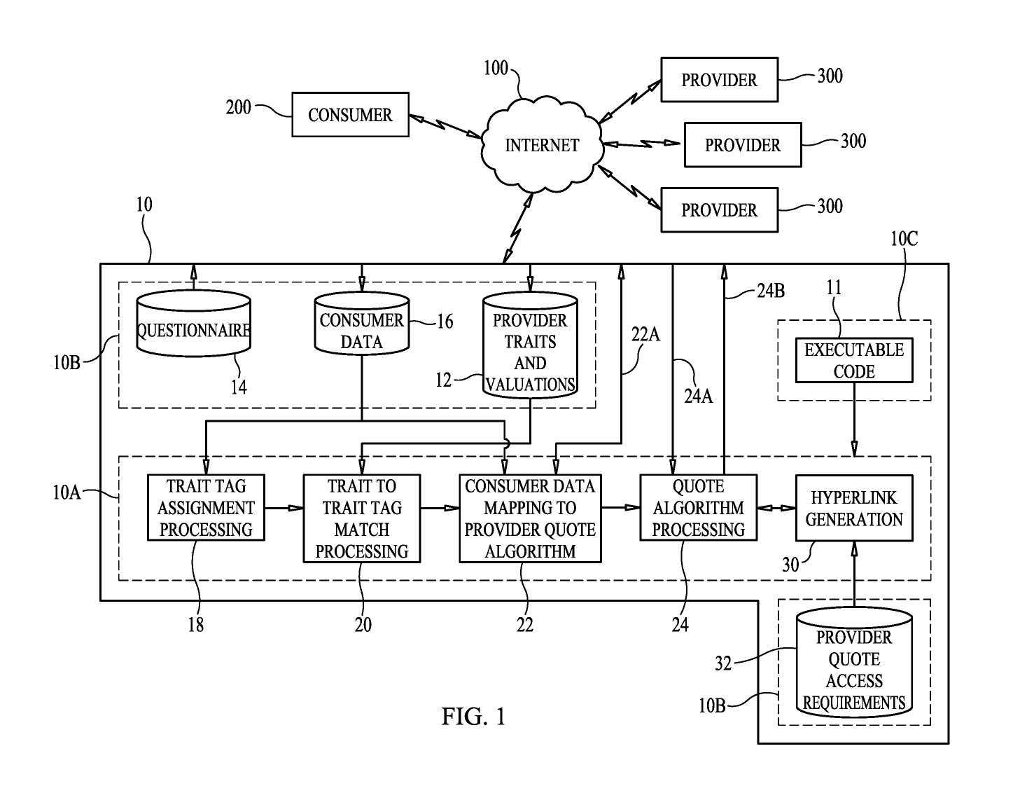

The present invention contemplates a system, method, and computer-readable medium for sales lead generation using trait-based matching of consumers to service providers operating in the same competitive industry. Referring now to the drawings and more particularly to FIG. 1, a top-level schematic view of a system for trait-based matching of a consumer to one or more auto insurance providers in accordance with an embodiment of the present invention is shown and is referenced generally by numeral 10. In general, the present invention generates sales leads for selected service providers that are most likely to give the best deal to a particular consumer because that particular consumer is the type of consumer desired by the selected service providers. By way of an illustrative example, the present invention will be explained for the case of auto insurance consumers and auto insurance providers. However, it is to be understood that the present invention is readily adapted to other types of insurance sales (e.g., health, life, disability, etc.) or, in general, sales of any service where a seller's price quote takes a consumer's traits into consideration. As used herein, the term “traits” refers to a consumer's distinguishing characteristics or situation as they relate to demographic or other quoting criteria or information associated with the service being sold. For the illustrated auto insurance example, such traits can include a consumer's name/address, driver's license number, birth date, marital status, level of education, employment information, as well as information generally associated with auto insurance such as length of time with current insurance provider, number of drivers to be insured, vehicle VIN(s), etc. It is to be understood that this list of traits is not limiting or exhaustive, and can be different without departing from the scope of the present invention.

System 10 can be a cloud-based system constructed for internet access and use such that consumers and providers access system 10 via the internet 100. While multiple consumers can access/use system 10 simultaneously, only one consumer 200 is shown and will be discussed herein to provide a description of the present invention. Consumer 200 can access system 10 using a computer or mobile device, the choice of which is not a limitation of the present invention. If access is via a computer, consumer 200 will access system 10 via a website linked to system 10. If access is via a mobile device, consumer 200 could access system 10 via a website linked to system 10 or via a mobile app. Both types of access/use are well understood in the art and will not be described further herein.

In an exemplary embodiment of the present invention, consumer 200 can access/use system 10 when purchasing a new/used vehicle from a vehicle retailer. As will be explained further below, one application of the present invention contemplates that vehicle retailers are subscribers of system 10 and allow their customers to use system 10 as a means of helping their customers obtain one or more auto insurance quotes from auto insurance providers whose demographic criteria is satisfied by the particular consumer's purchase and life situation. By way of an illustrative example, it is this application that will be used to describe the present invention. However, it is to be understood that consumers could also be permitted to independently access system 10 without departing from the scope of the present invention.

Auto insurance providers 300 desirous of getting leads from system 10 (i.e., a request for an insurance quote from consumer 200) provide system 10 with information about the types of customers and/or vehicles that they are most interested in having as insureds. In other words, each provider 300 identifies their preferred or most-valued demographics to include those related to the consumer and/or those related to the type(s) of vehicle they prefer to insure. The number of providers 300 accessing/using system 10 can range from 1 to N, and is not a limitation of the present invention. Each provider 300 identifies a number of generic consumer and/or vehicle traits along with a corresponding value. More specifically, the generic traits are defined by system 10 for all providers 300. Each provider 300 then selects ones of the generic traits that identify types of customers and/or vehicles they would like to insure. In addition, each provider 300 assigns a valuation (or ranking) to each selected trait. The rank or valuation can be a numeric value (e.g., positive, negative, or zero) with, for example, the rank or value being indicative of how important the trait is to the provider.

In an application of the present invention, providers 300 are subscribers of system 10 where trait valuation is used as a means of payment (e.g., to the owners and/or operators of system 10) for leads provided to providers 300. That is, the trait valuations can be (or associated with) payment values such as dollar amounts, bit coin amounts, purchase credits with provider 300, merchandise, etc., that a provider 300 is willing to pay (e.g., to the owner/operator of system 10) for a customer lead whose trait(s) match those selected by a particular provider. Accordingly, each provider 300 selects their preferred or most-valued generic consumer traits from those provided by system 10 and assigns trait valuations (e.g., a positive or negative dollar value to be paid a lead associated with a consumer having trait(s) that match one or more of the provider's traits) thereto. Such generic consumer trait choices could include, but are not limited to, new v. used vehicle, single v. multi-vehicle, marital status, education level, own home v. rent, employed v. unemployed, age, residence region, just to name a few.

System 10 can be realized in a variety of ways without departing from the scope of the present invention. For example, system 10 can be a server-based system having dedicated processor(s) 10A, data storage 10B, and computer-readable medium 10C. As would be well understood in the art, computer program(s) in the form of executable code 11 for implementing the method of the present invention can be stored on computer-readable medium 10C (i.e., some type of electronic data storage device) and executed by processor(s) 10A using data stored on data storage 10B. System 10 can also include a variety of well-known devices/systems (e.g., RAM, ROM, cache, input/output devices, communication devices, etc.) that facilitate processing. The inclusion of such devices/systems is well-known and understood in the art. System 10 could also be implemented on a third-party's processing platform without departing from the scope of the present invention. System 10 will be described herein showing separate data storage and processing blocks in order to facilitate an understanding thereof. However, it is to be understood that such separation need not be maintained in a realization of system 10.

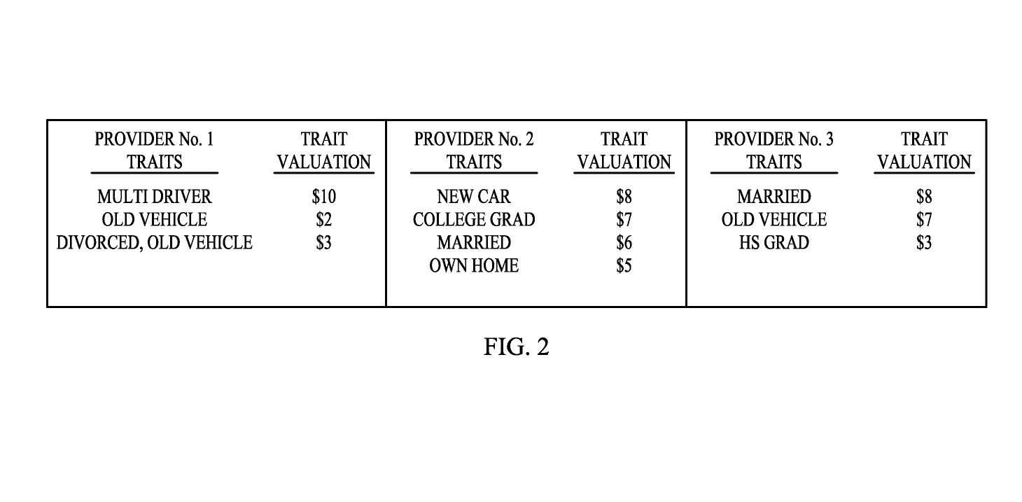

The above-described traits and their valuations are provided by each provider 300 to system 10 and are stored, for example, in a database 12. By way of an illustrative example, a table listing provider traits and their corresponding valuations for three fictitious providers is shown in FIG. 2. The number and type of traits selected, as well as their valuations, are decided upon by the providers. In this example, each valuation is a dollar value that the particular provider is willing to pay to the owner/operator of system 10 for a customer lead corresponding to a consumer having that trait. As is evident in the example and as is true in marketplace, different providers are looking for diverse traits. In general, a provider can be more price competitive when a consumer's traits are correlated or matched to those most desired by the provider.

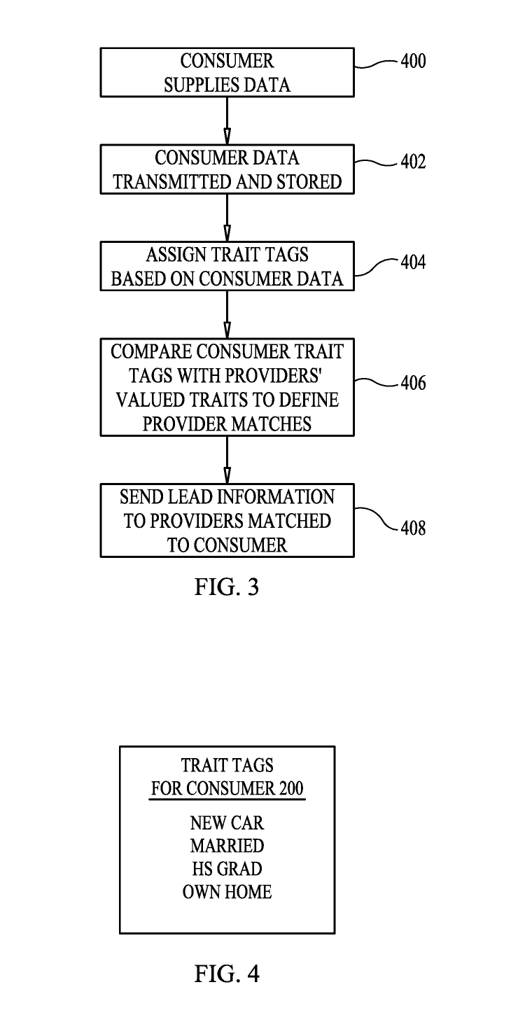

The present invention's lead generation method using trait-based matching will now be explained for the simple provider traits shown in FIG. 2 and with additional reference to the flow diagram in FIG. 3. When consumer 200 is to obtain quotes for auto insurance, consumer 200 supplies information to system 10 at step 400. For example, in the use of system 10 being accessed while consumer 200 is at an auto retailer, consumer 200 can fill out a questionnaire 14 transmitted by system 10 to the device (not shown) used by consumer 200 to access system 10. The questionnaire requests personal demographic information and vehicle demographic information that can be entered manually and/or scanned in (e.g., VIN number, driver's license, etc.). The consumer-provided information/data is transmitted to system 10 at step 402 for storage in a database where the stored data is referred to herein as consumer data 16. Trait tag assignment processing 18 processes each consumer's consumer data 16 to assign trait tags thereto at step 404 where the various trait tag possibilities are the same as the generic traits from which providers 300 select their traits for ranking/valuation as described above. A simple list of trait tags for a fictitious consumer 200 generated by trait tag assignment 18 is illustrated in the table shown in FIG. 4. In the illustrated example, the trait tags found in consumer data 16 for consumer 200 are “NEW CAR”, “MARRIED”, “HS GRAD” and “OWN HOME”. That is, as specified in consumer data 16, this particular consumer 200 is a high school graduate who is married, owns their home, and wants to obtain an insurance quote for a new car. It is to be understood that each consumer's trait tag list will most likely be relatively unique, and could include more or less trait tags than those shown in FIG. 4 without departing from the scope of the present invention.

After consumer data 16 has had trait tags assigned thereto, trait-to-trait tag match processing 20 compares, at step 406, a consumer's trait tags with the valued traits for those providers in database 12. In general, match processing 20 at step 406 correlates a consumer's data with the providers' specified traits to define or select one or more of providers whose traits correlate or match up well with the trait tags of consumer 200. Match processing 20 can employ a variety of correlation or matching approaches without departing from the scope of the present invention. For example, match processing 20 could be restricted to identifying a provider match only when the provider's top valued trait matches one of the consumer's trait tags. Another option is to sum valuations for all matched traits/trait tags. Assuming this latter option is employed by match processing 20, and the examples in FIGS. 2 and 3 are being compared, Provider No. 1 would generate a match score/fee of $0, Provider No. 2 would generate a match score/fee of $19, and Provider No. 3 would generate a match score/fee of $11. In this example, Provider Nos. 2 and 3 would get a lead and they would pay system 10 fees of $19 and $11, respectively, for the lead. In general, a lead is generated by sending information at step 408 to defined/selected providers 300 (e.g., Provider Nos. 2 and 3 in the illustrated example) about consumer 200 to thereby identify consumer 200 as a potential customer for the defined/selected providers. It is to be understood that the types of lead information sent to the defined/selected providers 300 can vary without departing from the scope of the present invention. A non-limiting exemplary lead generation information scheme that can be used in the present invention will be described below.

Information/data provided by lead generation in the present invention can take the form of consumer data 16 that has been paired down or mapped to satisfy that data requirements for a particular provider's quote algorithm. To accomplish this, system 10 includes consumer data mapping processing 22 that selects and presents portions of consumer data 16 to providers identified by match processing 20 that are relevant to the particular provider's quoting algorithm. For example, a provider's algorithm might only want the portions of the consumer data related to its valued traits along with basic consumer/vehicle identification information. By doing this, mapping processing 22 provides/sends (e.g., via the internet 100) each selected provider 300 consumer-identifying information (transmitted by system 10 as referenced by line 22A) that can be processed immediately by its quoting algorithm thereby greatly reducing the amount of time needed to generate an accurate quote.

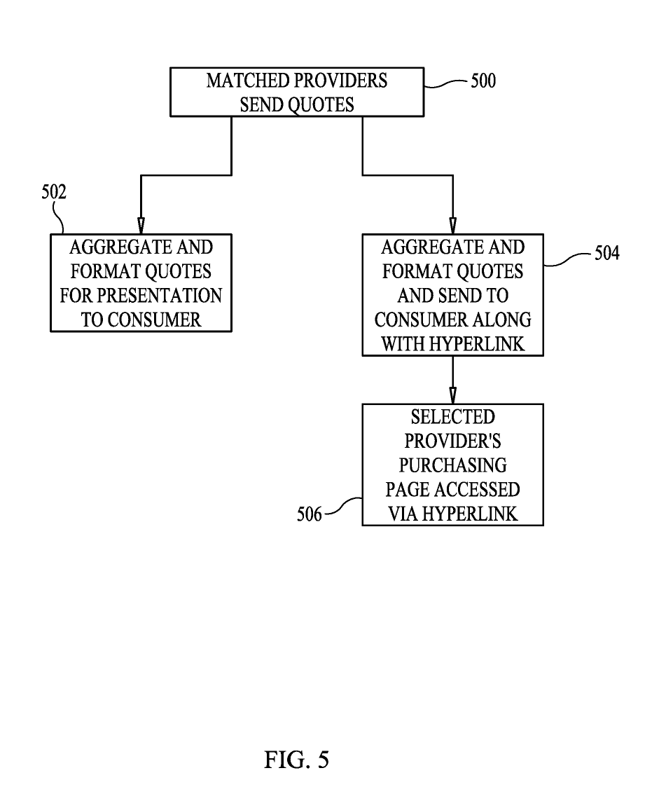

The present invention is not limited to lead generation and can be expanded to include post lead generation steps that further advance the purchasing process. A non-limiting exemplary post lead generation methodology will now be explained with additional reference to the flow diagram in FIG. 5. Using the lead information from step 408, the defined/selected providers 300 generate their quotes and transmit same back to system 10 at step 500 with the received quotes being indicated by line 24A. System 10 aggregates quotes 24A at quote aggregation processing 24. The aggregated quotes are formatted at step 502 for transmission to consumer 200 (as referenced by line 24B) and for presentation on, for example, a single “page” (e.g., screen, print out, etc.) made available to consumer 200. In this way, consumer 200 is presented with quotes from providers 300 that are desirous of insuring consumer 200. As mentioned above, since the quoting ones of providers 300 are most interested in the personal and/or vehicle demographic traits associated with consumer 200, the present invention is most likely to provide consumer 200 with competitive quotes from the quoting providers.

For providers 300 that accept online purchases, the present invention can additionally or alternatively format/present quotes at step 504 to include a purchasing hyperlink with each quote presented to consumer 200. More specifically, a hyperlink generator 30 is provided with the known quote access requirements 32 of each provider 300 (e.g., quote ID number, password needed along with quote ID number to enter purchasing page of providers, etc.). Hyperlink generator 30 creates a hyperlink that, when selected, will automatically take a user to a provider's entry page and enter a quote ID number, password, etc., on the provider's website entry page. The generated hyperlink is provided alongside the provider's quote presented to consumer 200. For example, the hyperlink could be associated with a purchase “button” presented to consumer 200. By selecting the button/hyperlink at step 506, the consumer gets to bypass the provider's entry page and is automatically taken to the provider's purchasing page directly associated with the consumer's quote. This eliminates the consumer's need to keep track of quote ID numbers, passwords, etc., thereby reducing the amount of time it takes to purchase insurance.

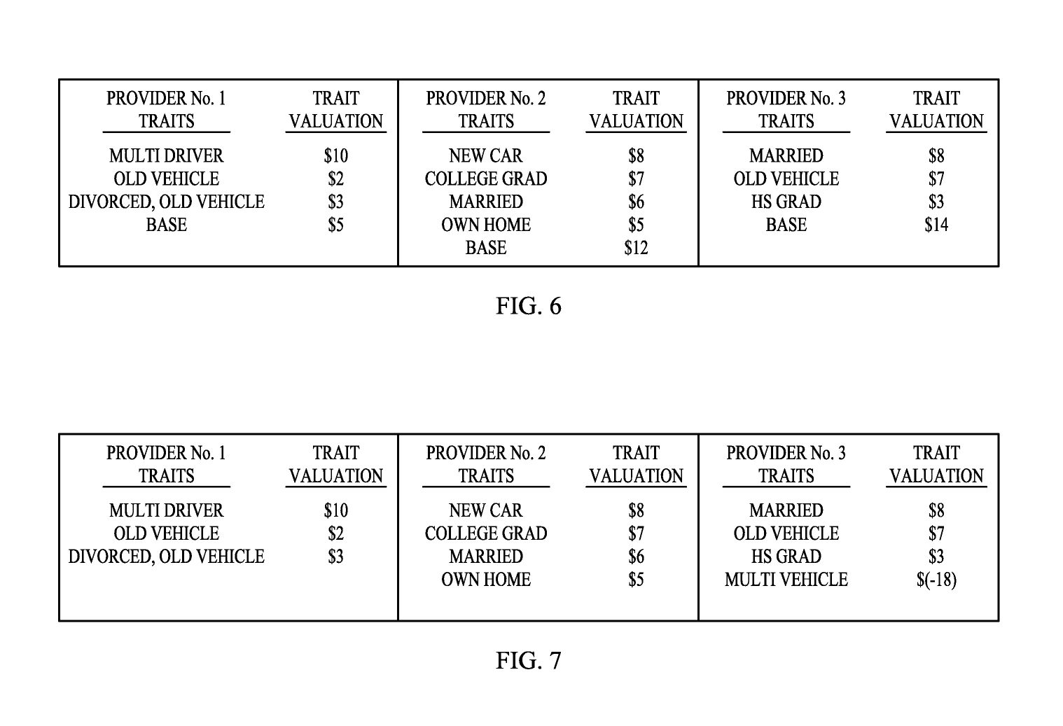

As mentioned above, a variety of provider traits and valuation schemes can be used without departing from the scope of the present invention. Two such embodiments are illustrated in the tables shown in FIGS. 6 and 7. In FIG. 6, one or more of the providers can have a BASE trait and score/fee associated therewith. The BASE value represents a monetary amount (or other payment valuation) that a provider is willing to pay for any lead even when no other trait is matched with a consumer's trait tags. The BASE value could be the same or different for providers without departing from the scope of the present invention. FIG. 7 illustrates another option where one or more providers can identify traits that are essentially “deal breakers” such that a match with that trait serves as an indication that no lead should be generated regardless of other matching traits. In the illustrated example, Provider No. 3 identifies MULTI VEHICLE with a valuation of $(−18), i.e., Provider No. 3 does not value/want any consumers having more than one vehicle. Accordingly, if a consumer's trait tags matched all of the other Provider No. 3 traits but had MULTI VEHICLE also, a score/fee of $0 would be generated to prevent a lead from being sent for that consumer to Provider No. 3. A score/fee that is negative would also prevent a lead from being sent. The features described in FIGS. 6 and 7 could also be incorporated into the present invention in combination without departing from the scope of the present invention.

Executable code 11 can include, for example, instructions and data which cause a general purpose computer, special purpose computer, or special purpose processing device to perform a certain function or groups of functions. As would be well understood in the art, executable code 11 can be stored on computer-readable medium 10C in the form of one or more program modules that are executed by processor(s) 10A as needed. As is well-known in the art, such program modules can include routines, programs, components, data structures, objects, and various functions inherent in the design of processors that perform particular tasks or implement particular executable instructions in order to implement the steps of the methods disclosed herein. The present invention is not limited by the particular sequence of executable instructions or associated data structures.

The advantages of the present invention are numerous. The system and method quickly and efficiently generates leads for service providers who are most interested in the traits associated with a particular consumer. The system and method can also provide one or more quotes to consumers from providers who are most interested in them and their situations. The present invention provides a platform for providers to define their interest in types of consumers/situations where the interest can be equated to a fee that the provider is willing to pay for a lead to a particular consumer. Thus, the system is simultaneously advantageous for both consumers and providers. Each provider generates quotes using only what they deem to be relevant information. The quotes are aggregated and presented on one “page” to a consumer. The system can generate a hyperlink for presentation with each quote that takes a consumer directly to a provider's purchasing page for the particular quote.

Although the invention has been described relative to specific embodiments thereof, there are numerous variations and modifications that will be readily apparent to those skilled in the art in light of the above teachings. It is therefore to be understood that the invention may be practiced other than as specifically described.

What is claimed as new and desired to be secured by Letters Patent of the United States is:

1. A method of generating sales leads for a service provider, comprising the steps of:
storing, in a first database, traits valued by each of a plurality of service providers operating in an identical competitive industry wherein, for each of said service providers, each of said traits identifies one of preferred consumer demographics and preferred business demographics;
collecting, in a second database, data from a consumer to include the consumer's personal information and information associated with a service provided by said service providers;
comparing, using a computing device coupled to the first database and the second database, said data with said traits of said service providers to identify at least one of said service providers having said traits that correlate to said data associated with the consumer; and
identifying, using the computing device, the consumer to said at least one of said service providers having said traits that correlate to said data associated with the consumer.

2. A method according to claim 1 wherein, for each of said service providers, each of said traits associated therewith has a rank assigned thereto, and wherein said step of comparing comprises the step of:
adding, for ones of said service providers having at least one of said traits specified by said data, said rank associated with each of said traits specified by said data to generate a score for each of said ones of said service providers, said score being a measure of correlation between said traits and said data.

3. A method according to claim 1, wherein said rank comprises a payment value.

4. A method according to claim 1, wherein said rank comprises a monetary value.

5. A method according to claim 1, wherein said step of identifying includes the step of:
sending at least a portion of said data to said at least one of said service providers having said traits that correlate to said data associated with the consumer.

6. A method according to claim 5, further comprising the step of:
receiving, for the consumer at the computing device, a quote for a service from said at least one of said service providers based on said portion of said data.

7. A method according to claim 1, wherein said service providers are insurance providers.

8. A system for generating sales leads for a service provider, comprising:
a processor; and
a computer-readable storage medium having instructions stored thereon that, when executed by said processor, cause said processor to perform operations comprising
storing traits valued by each of a plurality of service providers operating in an identical competitive industry wherein, for each of said service providers, each of said traits identifies one of preferred consumer demographics and preferred business demographics,
collecting data from a consumer to include the consumer's personal information and information associated with a service provided by said service providers,
comparing said data with said traits of said service providers to identify at least one of said service providers having said traits that correlate to said data associated with the consumer, and
identifying the consumer to said at least one of said service providers having said traits that correlate to said data associated with the consumer.

9. A system as in claim 8 wherein, for each of said service providers, each of said traits associated therewith has a rank assigned thereto, and wherein said computer-readable storage medium has additional instructions stored that, when executed by said processor, result in operations associated with said step of comparing that comprise:
adding, for ones of said service providers having at least one of said traits specified by said data, said rank associated with each of said traits specified by said data to generate a score for each of said ones of said service providers, said score being a measure of correlation between said traits and said data.

10. A system as in claim 8, wherein said rank comprises a payment value.

11. A system as in claim 8, wherein said rank comprises a monetary value.

12. A system as in claim 8, wherein said computer-readable storage medium has additional instructions stored that, when executed by said processor, result in operations associated with said step of identifying that comprise:
sending at least a portion of said data to said at least one of said service providers having said traits that correlate to said data associated with the consumer.

13. A system as in claim 12, wherein said computer-readable storage medium has additional instructions stored that, when executed by said processor, result in operations that comprise:
receiving, for the consumer, a quote for a service from said at least one of said service providers based on said portion of said data.

14. A system as in claim 13, wherein said computer-readable storage medium has additional instructions stored that, when executed by said processor, result in operations that comprise:
generating, for each one of said service providers from which said quote was received, a hyperlink specifying a website page directly associated with said quote that was received.

15. A system as in claim 8, wherein said service providers are insurance providers.

16. A computer-readable storage device having instructions stored that, when executed by a computing device, cause the computing device to perform operations comprising:
storing traits valued by each of a plurality of service providers operating in an identical competitive industry wherein, for each of said service providers, each of said traits identifies one of preferred consumer demographics and preferred business demographics;
collecting data from a consumer to include the consumer's personal information and information associated with a service provided by said service providers;
comparing said data with said traits of said service providers to identify at least one of said service providers having said traits that correlate to said data associated with the consumer; and
identifying the consumer to said at least one of said service providers having said traits that correlate to said data associated with the consumer.

17. A computer-readable storage device as in claim 16 wherein, for each of said service providers, each of said traits associated therewith has a rank assigned thereto, and wherein said computer-readable storage device has additional instructions stored that, when executed by the computing device result in operations associated with said step of comparing that comprise:
adding, for ones of said service providers having at least one of said traits specified by said data, said rank associated with each of said traits specified by said data to generate a score for each of said ones of said service providers, said score being a measure of correlation between said traits and said data.

18. A computer-readable storage device as in claim 16, wherein said rank comprises a payment value.

19. A computer-readable storage device as in claim 16, wherein said rank comprises a monetary value.

20. A computer-readable storage device as in claim 16, wherein said computer-readable storage device has additional instructions stored that, when executed by the computing device, result in operations associated with said step of identifying that comprise:
sending at least a portion of said data to said at least one of said service providers having said traits that correlate to said data associated with the consumer.

21. A computer-readable storage device as in claim 20, wherein said computer-readable storage device has additional instructions stored that, when executed by the computing device, result in operations that comprise:
receiving, for the consumer, a quote for a service from said at least one of said service providers based on said portion of said data.

22. A computer-readable storage device as in claim 21, wherein said computer-readable storage device has additional instructions stored that, when executed by the computing device, result in operations that comprise:
generating, for each one of said service providers from which said quote was received, a hyperlink specifying a website page directly associated with said quote that was received.

23. A computer-readable storage device as in claim 16, wherein said service providers are insurance providers.
